(19) United States
(12) Patent Application Publication
(10) Pub. No.: US 2026/0128537 A1
(43) Pub. Date: May 7, 2026

(54) CONNECTOR WITH IMPROVED CONTACT SPRING ELEMENTS

(71) Applicant: iwis smart connect GmbH, Rieden am Forggensee (DE)

(72) Inventors: Florian BRUHN, Türkheim (DE); Akshata Ankush SANGLE, Kaiserslautern (DE)

(21) Appl. No.: 19/380,879

(22) Filed: Nov. 5, 2025

(30) Foreign Application Priority Data
Nov. 6, 2024 (DE) 102024132351.5

(51) Int. Cl. H01R 12/70; H01R 12/73

(52) U.S. Cl. CPC H01R 12/7023; H01R 12/732

(57) ABSTRACT

A connector for electromechanically connecting two contact devices, preferably with a polygonal cross-section, preferably plug-in tabs of busbars and/or PCBs is provided. The connector includes a main-connector body, which has a hollow shape and into which the contact devices can be inserted from both sides, and a contact spring element, mounted in the main-connector body. The contact spring element has a first frame, a second frame, and at least six flat springs connecting the first and second frames to each other. At least two flat springs arranged next to each other extend from a frame spar of the first frame to a corresponding frame spar of the second frame. At least the two flat springs arranged next to each other each have a larger current flow cross-section in the area assigned to a connection point of the contact devices than in adjacent areas of the corresponding flat spring.

### CROSS-REFERENCE TO RELATED APPLICATION

This application claims priority to foreign German patent application No. DE 102024132351.5, filed on Nov. 6, 2024, the disclosure of which is incorporated by reference in its entirety.

### FIELD OF THE INVENTION

The present invention relates to a connector for the electromechanical connection two contact devices, preferably plug-in tabs of busbars and/or PCBs.

### BACKGROUND

In electromechanical contacting of, for example, contact tabs or busbars, it is common for a contact shoe, contact connector, etc., formed from sheet metal to have a contact spring arrangement (for example, in the form of a contact or lamella cage) inside so that the mating contact is inserted under spring preload. In the case of flat, particularly rectangular plug-in tabs, the corresponding spring-loaded contacting of the upper and lower sides of the plug-in tab is provided. In many cases, several spring tabs in the form of flat/lamellar springs are produced to provide the corresponding spring contacting. Examples of such arrangements can be found in DE 10 2005 033 696 A1 and DE 10 2019 119 405 A1. What these designs have in common is that they are each adapted to the corresponding plug-in element. However, the designs shown there are not suitable for directly or immediately connecting two contact tab tongues.

Due to advancing electrification, including in the automotive sector, there is increasing demand for high-voltage and high-current applications. In particular, busbar rails must be connected directly to each other. Heat generation in such connectors is often a limiting factor for acceptable current transmission.

### SUMMARY OF THE INVENTION

The present invention therefore aims to improve a corresponding connector in terms of its permissible current transmission rate.

This task is solved by a connector according to claim 1. The connector for electromechanically connecting two contact devices, preferably with a polygonal cross-section, preferably plug-in tabs of busbars and/or PCBs, comprises a main-connector body, which has a hollow shape and into which the contact devices can be inserted from both sides, and a contact spring element, which is mounted in the main-connector body. The polygonal cross-section may also have strongly rounded corners, e.g., a rectangle with strongly rounded corners. The contact spring elements have a first frame, a second frame, and at least six flat springs connecting the first and second frames to each other, wherein at least two flat springs arranged next to each other extend from a frame spar of the first frame to a corresponding frame spar of the second frame. At least the two flat springs arranged next to each other each have a current flow cross-section that is larger than adjacent areas of the corresponding flat spring in the area assigned to a connection point of the contact devices. The inventors have demonstrated through experiments that increasing the current flow cross-section of the flat springs precisely in the area that represents the actual connection point between the two contact devices reduces the temperature load on the connector under otherwise identical boundary conditions. Accordingly, this simple measure allows the connector according to the invention to be subjected to higher loads and thermal limits are reached less quickly. The increase in the current flow cross-section only needs to take place in this area of the flat springs. The remaining areas of the flat springs can manage with a smaller current flow cross-section. The “joint” between the two contact devices within the connector is considered to be the connection point, although the two contact devices do not necessarily have to touch each other. In such connections, the two end faces of the contact elements, in particular the plug-in tabs, are usually opposite each other. There is no overlap of the contact elements.

Preferably, the enlarged current flow cross-section of the at least two flat springs arranged next to each other can be formed by means of a crossbar connecting the at least two flat springs arranged next to each other. The corresponding spring tongues are formed contiguously in this area by means of the crossbar. Such a crossbar can be produced very easily, particularly in a stamped-bent design of the contact element. If the crossbar is also supported by the main-connector body and the latter is sufficiently thermally conductive, additional heat can be dissipated. A material bond between the crossbar and the main-connector body is also possible.

According to one embodiment, the crossbar can have a width in the range of 5% to 30%, preferably in the range of 15% to 20%, of the length of the associated flat springs. The length of the flat springs is essentially determined by the distance between the first and second frames. This results in a considerable increase in the current flow cross-section in this section and thus improved thermal properties.

Favourably, the flat springs of the contact spring elements can have two or more main arcs, each protruding inward into a plug-in space of the main-connector body, in the direction of insertion, with a corresponding transition bend between them, such that at least one main bend can be brought into contact with one contact device and at least the transition bend in the area assigned to the connection point of the contact devices rests against or is connected to the main-connector body. The main bends of the flat springs each contact the associated surfaces of the contact devices and receive or transmit the current flow, while the transition bend in the area associated with the connection point of the contact devices is primarily responsible for the current transmission from one contact element to another. While the main bends preferably rest resiliently on the wide surfaces of the contact elements, a comparable resilient property of the transition bend assigned to the connection point is not absolutely necessary, which is why a strongly flattened shape of the transition bend is also sufficient. It is possible to construct the contact spring element from two half-elements, which are then welded to the main-connector body in the transition area. In such a variant, for example, each half-element can have only a single main bend and the transition bend can be formed at least partially by the weld.

For this reason, at least the transition bend in the area assigned to the connection point of the contact devices may have a flattened section for attachment to or connection with the main-connector body. On the one hand, the force exerted on the main-connector body is distributed over a larger area and the surface load in this area is reduced. On the other hand, provided that the main-connector body is a good heat conductor, increased contact ensures that the heat generated is dissipated.

Preferably, the length of the flattened section measured in the plugging direction can be at least 5% of the length of the corresponding flat spring. This alone can already achieve a considerable advantage.

It is particularly advantageous if the transition bends in the area of the connection point of the contact devices associated with at least two flat springs arranged next to each other are connected to each other by means of the crossbar. This makes the corresponding transition bends significantly stiffer than the main bends and increases not only the contact area with the main-connector body but also the current-carrying cross-section.

In another embodiment, at least one flat spring is provided with a stop tab protruding inwardly into the insertion space of the main connecting body, which is designed as an insertion stop for at least one of the contact devices. This prevents at least one of the contact devices from being inserted completely. This has advantages during assembly. Advantageously, the stop tab can also be arranged exactly between two end faces of the contact devices so that they are kept at a precise distance. The current then flows specifically via the contact spring elements because the contact elements do not touch each other directly. Preferably, several of these stop tabs can be provided (for example, two).

In one variant, the stop tab can be produced particularly favorably if it is arranged in extension of the crossbar. At the end of the crossbar, the stop tab can, for example, be formed simply by bending. In a further embodiment, at least one of the flat springs has a projection at least transverse to the longitudinal extension of the at least one main bend, which projects inwards into the plug-in space of the main-connector body and forms the main contact zone of the flat spring and contact device in this area when plugged in. Such a projection also increases the spring constant of the flat spring and ensures increased contact pressure.

Preferably, the projection can be formed by an embossment in the at least one flat spring. The embossment allows the contact geometry of the corresponding flat spring to be modified. Depending on the design, this can also increase the contact pressure on the contact elements. Furthermore, an embossment is very easy to produce and can be integrated very well into a stamping and bending process in particular.

However, in another embodiment, it is entirely possible for the embossment to form a projection protruding outward from the contact spring elements, resulting in contact zones separated from each other on the inside of the associated flat spring due to the embossment. If, for example, an elongated, central embossment is created along the main bend, this results in two strip-shaped contact zones of the corresponding flat spring. This increases the number of contact points, which can be advantageous for certain applications.

The most common contact elements are contact tabs or busbars. These are relatively flat, i.e., their thickness is significantly less than their width (at least a ratio of 1:2, e.g., 3 mm×10 mm, 6 mm×14 mm, 4 mm×40 mm, and 3.5 mm×14 mm). Therefore, according to one embodiment, it is advantageous if at least two of the flat springs arranged next to each other on the wide side of the contact spring elements have an enlarged current flow cross-section in the area assigned to a connection point of the contact elements. If flat springs are also present on the side surfaces of the contact spring elements, these do not have an enlarged current flow cross-section in this embodiment or are not connected to each other by a crossbar.

Accordingly, according to a variant, at least one flat spring may also have an embossment only on the wide side of the contact spring elements.

Due to the optimization of the contact spring elements, it is also possible to design the main-connector body purely on the basis of strength considerations. According to one embodiment, it can therefore be made of an electrically non-conductive material. The connector then automatically provides protection against accidental contact, which is particularly advantageous in combination with contact elements that are only stripped in the plug-in area, for example, insulated busbars with plug-in tabs at the ends. Alternatively, the main-connector body can be made of inexpensive sheet steel with an insulating plastic body surrounding it.

### BRIEF DESCRIPTION OF THE DRAWINGS

The following describes an embodiment of the present invention in more detail with reference to drawings. They show:

FIG. 1 a perspective view of a connector according to the invention with two busbars that are not yet fully plugged in,

FIG. 2 an enlarged perspective view of the connector according to the invention from FIG. 1,

FIG. 3 a perspective view of the contact spring elements from FIG. 2,

FIG. 4 a reduced top view of the contact spring elements from FIG. 3,

FIG. 5 the contact spring elements from FIG. 3 in full section along line V-V,

FIG. 6 the contact spring elements from FIG. 3 in enlarged section along line VI-VI, and

FIG. 7 an embodiment of a busbar with a strongly rounded polygonal cross-section.

### DETAILED DESCRIPTION

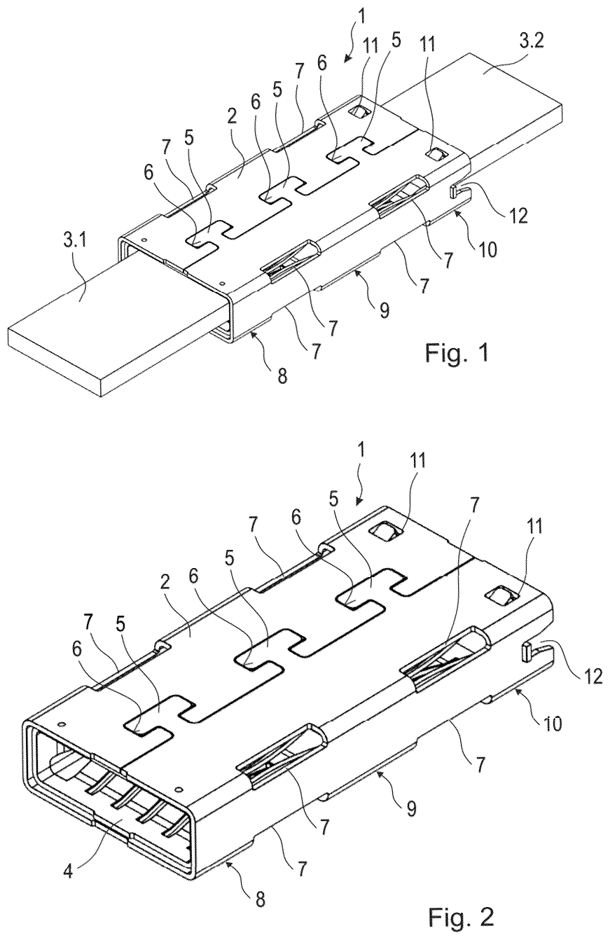

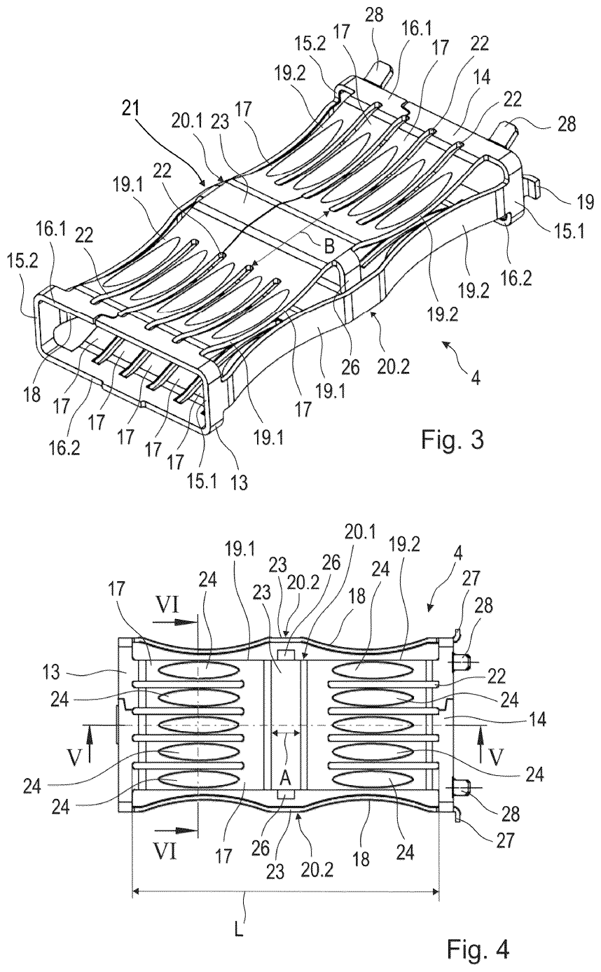

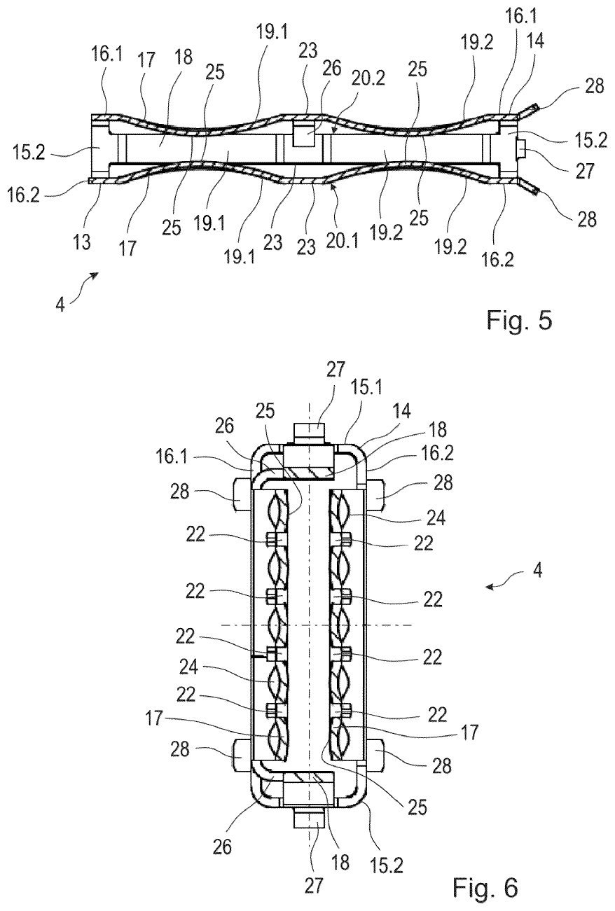

FIG. 1 shows a connector 1 that is designed to connect the rectangular plug-in tabs 3.1, 3.2 of two busbar rails. The connector 1 comprises a main-connector body 2, which has a quadrangular hollow shape, and a pair of contact spring elements 4 inserted into the main-connector body 2. The main-connector body 2 is made of sheet metal and is manufactured by a punching/bending process. One end of the sheet metal has three mating recesses 5 and the second end has three complementary joining projections 6, which interlock precisely after the joining process and lock the rectangular shape of the main-connector body 2. Alternatively, welding can also be carried out without using mating recesses 5 and joining projections 6. Furthermore, the main-connector body 2 is provided with a total of eight corner recesses 7. This forms three parallel, band-shaped, surrounding rectangular frames 8, 9, and 10 on the main-connector body 2. The first band-shaped frame 8 is located at the first insertion end of the main-connector body 2. The second band-shaped frame 9 is positioned approximately in the center of the main-connector body 2. The central mating recess 5 and the central mating projection 5 are located within the second band-shaped frame 9. The third band-shaped frame 10 is located at the second insertion end of the main-connector body 2. Two window recesses 11 are provided on each of the upper and lower sides of the third band-shaped frame 10, which serve to lock the contact spring elements 4 in place in a manner to be described in more detail below. Open recesses 12 are provided on the sides of the third band-shaped frame 10 toward the front side, which also serve to position the contact spring elements 4. The length of the main-connector body 2 is longer than the length of the contact spring elements 4, so that the latter is completely accommodated inside the main-connector body 2.

The contact spring elements 4 are also made from sheet metal by punching/bending and consist of a highly conductive material, such as copper or a copper alloy. The contact spring elements 4 have a first rectangular frame 13, which is arranged at the first end of the contact spring elements 4, and a second rectangular frame 14, which is positioned at the second end region of the contact spring elements 4. Each of these two rectangular frames 13 and 14 has four frame rails 15.1, 15.2, 16.1, and 16.2. The frame rails 15.1 and 15.2 are the two frame rails that run in the thickness direction of the plug-in tabs 3.1, 3.2 to be accommodated. The two frame rails 16.1 and 16.2 are the two frame rails that run in the width direction of the plug-in tabs 3.1, 3.2. The transitions between the frame rails 15.1, 15.2, 16.1, 16.2 are rounded. Between the frame rails 16.1 of the first and second rectangular frames 13 and 14 and the frame rails 16.2 of the first and second rectangular frames 13 and 14, there are five flat springs 17 arranged next to each other in a lamellar manner (the number is at least two and is adapted to the width of the plug-in tabs 3.1, 3.2). Between the frame rails 15.1 of the first and second rectangular frames 13 and 14 and the frame rails 15.2 of the first and second rectangular frames 13 and 14, there is one flat spring 18 (the number is 0 or more and is adjusted to the thickness of the plug-in tabs 2, 3). The flat springs 17 each have an identical shape and size, and the flat springs 18 also each have an identical shape and size. All flat springs 17 and 18 extend parallel to the longitudinal extension of the contact spring elements 4.

The frame rails 15.1, 15.2, 16.1, 16.2 and the ends of the flat springs 17, 18 merge into one another because they are formed from the same sheet metal material and are thus firmly connected to one another. The flat springs 17, 18 are stretched between the two rectangular frames 13 and 14 and are fixed to them. Each of the flat springs 17, 18 has two main bends 19.1 and 19.2 arranged one behind the other, each of which is curved convexly toward the interior of the contact spring elements 3. The apexes of the main bends 19.1 and 19.2 are thus located further inside in relation to an axis of the contact spring elements 4 than the corresponding frame rails 15.1, 15.2, 16.1, 16.2. Both main bends 19.1 and 19.2 are of equal size and are connected to each other centrally between the two rectangular frames 13 and 14 by means of a transition bend 20.1 and 20.2, respectively. A significant difference between the flat springs 17 and 18 lies in the specific design in the area of the corresponding transition bends 20.1 and 20.2.

The flat springs 17 are connected to each other in their central area, which covers the actual connection point of the two plug-in tongues 3.1 and 3.2, by means of a relatively wide crossbar 21. This means that the entire transition bend 20.1 is formed from a substantially continuous sheet metal material. Adjacent to the transition bend 20.1, the flat springs 17 are separated from each other by means of a longitudinal recess 22. To form the crossbar 21, the longitudinal recess 22 is interrupted in the middle section. In the present case, the width B of the crossbar 21 is approximately 25% of the length L of the flat springs 17 (corresponding to a range of 5% to 30% of the length L). For this reason, the crossbar 21 also partially takes on the shape of the adjacent main arcs 19.1. The crossbar 21 increases the current flow cross-section of the flat springs 17 precisely in the area above and below (with reference to FIG. 1) the adjacent plug-in tabs 3.1, 3.2, i.e., where the main current transfer between the first and second plug-in tabs 3.1, 3.2 takes place via the contact spring elements 4. In the middle section 23, the crossbar 21 and thus also the transition bend 20.1 are flattened at this point, resulting in a large contact area on the inside of the main-connector body 2. This middle, flattened section 23 has a length A which, in the present case, corresponds to approximately 10% of the length L of the flat springs 17 (thus corresponding to at least 5% of the length L). In the present case, the middle, flattened section 23 is completely flat and runs parallel to the plugging plane of the connector 1.

The flat springs 18 have a uniform width. The arc shape of the two main bends 19.1, 19.2 of the flat springs 18 is identical to the design of the main bends 19.1, 19.2 of the flat springs 17. The transition bend 20.2 of the flat springs 18 is formed solely by the middle, flattened section 23. The middle, flattened section 23 rests against the inside of the main-connector body 2, and the two main bends 19.1, 19.2 protrude inward into the plug-in space of the main-connector body 2, so that they come into spring-loaded contact with the side surfaces of the plug-in tabs 3.1, 3.2.

A right-angled stop tab 26 is provided in the end extension of each crossbar 21 (the upper one in FIG. 2). The stop tab 26 protrudes into the insertion space of the main-connector body 2, so that an inserted plug-in tab 3.1 or 3.2 can be inserted up to a maximum of this stop tab 26. The width of the stop tab 26 then also influences the front-end distance between the two inserted plug-in tabs 3.1 and 3.2 and is therefore smaller than the width of the crossbar 21 and the middle, flattened section 23.

The flat springs 17 each have a lens-shaped embossment 24 (in the top view) in the center of their main bends 19.1, 19.2. The width of the embossment 24 is slightly narrower than the width of the flat spring 17 (corresponding to the preferred range of 50-95% of the width of the flat spring 17), and the length of the embossment 24 corresponds to approximately 30% of the length L of the flat spring 17 (and thus to the preferred range of 10-40% of the length L). The embossment 24 thus forms a dome-shaped projection 25 that protrudes inward into the plug-in space of the main-connector body 2 and forms the main contact zone for the respective associated plug-in tab 3.1 or 3.2. The projection 25 reduces the radius of curvature of the respective main bend 19.1, 19.2 in the area of the embossment 24. The depth of the embossment 24 is a maximum of a few tenths of a millimeter.

In the present embodiment, the flat springs 18 do not have such an embossment. However, such embossments could easily be provided.

In the variant shown, five flat springs 17 are attached to each of the horizontal frame beams 16.1, 16.2 (as shown in the illustration), while one flat spring 18 is attached to each of the vertical frame beams 15.1, 15.2 (as shown in the illustration). Due to the shape of the flat springs 17, 18, the contact spring elements 3 have a double taper inside. In the area of these narrow points, the contact spring elements 3 come into contact with the inserted plug-in tabs 3.1, 3.2, so that the flat springs 17 exert spring forces on the upper and lower sides and the flat springs 18 exert spring forces on the side surfaces of the plug-in tabs 3.1, 3.2. At the same time, the middle, flattened section 23 inside the main-connector body 2 can rest on the second band-shaped frame 9, so that the spring forces applied by the two main bends 19.1 and 19.2 to the inserted plug-in tabs 3.1, 3.2 can take effect accordingly.

A projection angle 27 is arranged on each of the vertical frame beams 15.1, 15.2 of the second rectangular frame 14, which is inserted into the recess 12 on the third band-shaped frame 10 and rests against the bottom of the recess 12 as a stop. Two springs 28 are arranged at a distance from each other on each of the horizontal frame beams 16.1 and 16.2 of the second rectangular frame 14, which protrude upwards and snap into the window recesses 11 of the third band-shaped frame 10 when the contact spring elements 4 are inserted. In conjunction with the projection angles 27, this connects the contact spring elements 4 to the main-connector body 2.

In the present case, connector 1 is an effective component with which two square contact devices, preferably plug-in tabs 3.1, 3.2 of busbars and/or PCBs, can be connected to each other. The first plug-in tab 3.1 is inserted from one side of the connector 1 and the other plug-in tab 3.2 is inserted from the other side of the connector 1. The projections 25 of the main bends 19.1, 19.2 then come into contact with the upper and lower sides of the plug-in tabs 3.1 and 3.2. The flat springs 18 arranged laterally ensure that the side surfaces of the plug-in tabs 3.1, 3.2 are also involved in the contact.

In the present case, with the exception of the crossbar 21, the flat springs 17 are of uniform width along their length and all flat springs 17 have the same width. The flat springs 18 also have this width. The individual flat springs 17, 18 are relatively narrow (lamellar) in relation to the total width of the contact spring elements 4 (in this case less than 12% of the total width of the contact spring elements 4).

The connector 1 shown in FIG. 1 is designed for a specific size of square contact devices, in particular the plug-in tabs 3.1, 3.2. A wide variety of sizes with a different number of flat springs 17 (at least two) and flat springs 18 can be produced by adapting the main-connector body 2 accordingly.

Tests have shown that, due to the increase in the current flow cross-section in the middle section of contact spring elements 4 compared to a connector of identical construction with flat springs of uniform width, much less heat is generated due to the same high current transmission. This means that, with the same current flow, smaller connectors and contact elements can be used due to this design, or that connectors and contact elements of the same size can be loaded with a higher current flow before a thermal limit occurs.

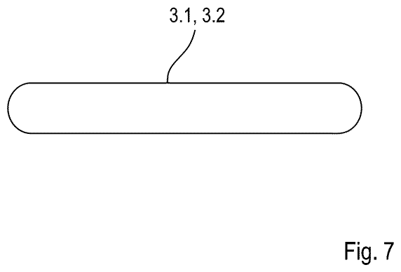

The current rails 3.1 and 3.2 can have a wide variety of polygonal cross-sections. In some cases, busbars 3.1 and 3.2 can be chamfered or rounded at the corners and edges. It is even possible to round them so much that at least some of the side surfaces are completely curved (as shown in FIG. 7 for a rectangular cross-section).

### LIST OF REFERENCE SIGNS

1 Plug connector
2 Connector main-connector body
3.1 First plug-in tab
3.2 Second plug-in tab
4 Contact spring elements
5 Mating recess
6 Mating projection
7 Corner recess
8 First band-shaped frame
9 Second band-shaped frame
10 Third band-shaped frame
11 Window recess
12 Recess
13 First rectangular frame
14 Second rectangular frame
15.1 First vertical frame beam
15.2 Second vertical frame beam
16.1 First horizontal frame beam
16.2 Second horizontal frame beam
17 Flat spring (top and bottom)
18 Flat spring (lateral)
19.1 First main bend
19.2 Second main bend
20.1 Transition bend flat spring 17
20.2 Transition bend flat spring 18
21 Cross bar
22 Longitudinal recess
23 Middle, flattened section
24 Embossment
25 Projection
26 Stop tab
27 Projection angle
28 Spring tongue
B Width of cross bar
L Length of flat spring
A Length of middle, flattened section

1. A connector for the electromechanical connection of two contact devices, preferably plug-in tabs of busbars and/or PCBs, with a main-connector body that has a hollow shape and into which the contact devices can be plugged in from both sides, and with contact spring elements which is mounted in the main-connector body, wherein the contact spring elements have a first frame, a second frame and at least six flat springs connecting the first and second frames to each other connecting the first and second frames to each other, wherein at least two flat springs arranged next to each other extend from a frame spar of the first frame to a corresponding frame spar of the second frame, and wherein at least the two flat springs arranged next to each other each have a current flow cross-section that is enlarged in comparison to adjacent areas of the corresponding flat spring in their area assigned to a connection point of the contact devices.

2. The connector according to claim 1,
wherein the respective enlarged current flow cross-section of the at least two flat springs arranged next to each other is formed by means of a crossbar connecting the at least two flat springs arranged next to each other.

3. The connector according to claim 1,
wherein the crossbar has a width (B) which is in the range of 5% to 30% of the length (L) of the associated flat springs.

4. The connector according to claim 2,
wherein the flat springs of the contact spring elements have two or more main bends which each project inwardly into a plug-in space of the main-connector body and follow one another in the plug-in direction, with a corresponding transition bend between them, such that at least one main bend can be brought into contact with one contact device and at least the transition bend rests against or is connected to the main-connector body in the area associated with the connection point of the contact devices.

5. The connector according to claim 2,
wherein at least the transition bend in the area associated with the connection point of the contact devices has a flattened section for abutment against or connection to the main-connector body.

6. The connector according to claim 5,
wherein the length (A) of the flattened section measured in the plug direction corresponds to at least 5% of the length (L) of the corresponding flat spring.

7. The connector according to claim 4,
wherein the transition bends are connected to each other by means of the crossbar in the area of the at least two flat springs arranged next to each other, which is associated with the connection point of the contact devices.

8. The connector according to claim 1,
wherein at least one flat spring has a stop tab molded onto it, which protrudes inwardly into the plug-in space of the main connector body and is designed as an insertion stop for at least one of the contact devices.

9. The connector according to claim 8,
wherein the stop tab is arranged in extension of the crossbar.

10. The connector) according to claim 4,
wherein at least one of the flat springs has, at least transversely to the longitudinal extension of at least one main bend has a projection which protrudes inwardly into the plugging space of the main-connector body and, in this area, forms the main contact zone of the flat spring and contact device when plugged in.

11. The connector according to claim 10,
wherein the projection is formed by means of an embossment in the at least one flat spring.

12. The connector according to claim 10,
wherein the embossment forms a projection protruding outwardly from the contact spring elements, whereby contact zones separated from each other by the embossment are created on the inside of the associated flat spring.

13. The connector according to claim 1,
wherein only on the wide side of the contact spring elements at least two of the flat springs arranged next to each other have an enlarged current flow cross-section in their area assigned to a connection point of the contact spring device.

14. The connector according to claim 2,
wherein only on the wide side of the contact spring elements at least one flat spring has an embossment.

15. The connector according to claim 1,
wherein the main-connector body is made of an electrically non-conductive material.
